(19) United States
(12) Patent Application Publication
(10) Pub. No.: US 2014/0369277 A1
(43) Pub. Date: Dec. 18, 2014

(54) Method and Apparatus for Communication Using a Shared Uplink Wireless Communication Channel

(71) Applicant: Broadcom Corporation, Irvine, CA (US)

(72) Inventors: Karl Marko Juhani LAMPINEN, Oulu (FI); Arto Johannes LEHTI, Oulu (FI); Tao CHEN, Espoo (FI)

(21) Appl. No.: 14/302,811

(22) Filed: Jun. 12, 2014

(30) Foreign Application Priority Data
Jun. 14, 2013 (GB) 1310650.5

(51) Int. Cl. H04W 72/04; H04W 52/14

(52) U.S. Cl. CPC H04W 72/042; H04W 52/146
USPC 370/329

(57) ABSTRACT

A method of transmitting data by a user equipment using a shared uplink wireless communication channel is described. The method includes receiving a power grant corresponding to the allowed transmission power on the shared uplink wireless communication channel. Also, the user equipment receives a scheduling grant corresponding to whether transmission is allowed on the shared uplink wireless communication channel. The user equipment transmits data on the shared uplink wireless communication channel according to the power grant and the scheduling grant, wherein the power grant is received separately from the scheduling grant. A corresponding method of controlling transmission, apparatus and computer program product is also described.

### TECHNICAL FIELD

The present invention relates to a method, apparatus and computer program product for transmission of data using a shared uplink wireless communication channel and a method, apparatus and computer program product for controlling the transmission of data using a shared uplink wireless communication channel. Embodiments are applied to 3GPP Enhanced Uplink (EUL) and High Speed Uplink Packet Access (HSUPA).

### BACKGROUND

3GPP wireless communication systems can provide Enhanced Uplink (EUL) or High Speed Uplink Packet Access (HSUPA) for transmissions on the uplink, from the User Equipment (UE) to the network node. In HSUPA, an Enhanced Dedicated Channel (E-DCH) is provided as a transport channel for user data. The E-DCH comprises two channels in the uplink: the E-DCH Dedicated Physical Data Channel (E-DPDCH) and the E-DCH Dedicated Physical Control Channel (E-DPCCH). On the downlink the E-DCH comprises three channels: the E-DCH Absolute Grant Channel (E-AGCH), the E-DCH Relative Grant Channel (E-RGCH) and the E-DCH Hybrid ARQ Indicator Channel (E-HICH).

Transmissions in HSUPA use a transmission time interval (TTI). The TTI can be, for example, 2 ms or 10 ms. The UE can operate in several modes, including CELL_DCH, in which there is a dedicated physical channel, and CELL_FACH in which several UEs can access a contention-based shared uplink communication channel.

In CELL_FACH and CELL_DCH mode, a UE can be allocated an absolute grant by a message on the E-AGCH. The absolute grant defines a serving grant in terms of the maximum transmission power allowed by the UE on the E-DPDCH. Only one UE can be addressed via the E-AGCH each TTI. Once given a non-zero serving grant, the UE can transmit on the E-DPDCH until allocated a zero serving grant.

Unlike the absolute grant on the E-AGCH, The E-RGCH can signal a relative grant for several UEs in the same TTI. The relative grant signals incremental changes to an existing serving grant. It can signal a single up or down change to the serving grant for a particular UE in each TTI, with reference to predetermined transmission formats defined in the 3GPP specification.

Increased uplink data rates are desirable. One way to achieve this is to allocate an absolute grant corresponding to a high Rise Over Thermal (RoT) value. This provides a high Signal to Inference plus Noise Ratio (SINR) required for reliable transmission at higher data rates. However, the E-DCH channels were designed for sharing of the channels using code division multiple access (CDMA) or code division multiplexing (CDM) where individual transmissions are made substantially simultaneously and differentiated by different spreading or scrambling codes. A single UE may use multiple spreading codes to increase the transmitted data rate. At high RoT values the transmissions of each user generally cause more interference to the transmissions of other users also communicating with the same network node using code division. This increased interference reduces the achievable data rate and may cause power control instability issues. As RoT values rise to allow increased uplink data rates, a mechanism is needed to limit the number of UEs which transmit in a single TTI and allow more flexible scheduling. The existing control protocols in HSUPA are not well suited to this.

A serving grant remains in place until it is reconfigured. Use of the E-AGCH to alter the serving grant is resource intensive and slow because it requires two transmissions (one to start, one to stop); each transmission takes a whole TTI and only one UE can be addressed in each TTI. Use of the E-RGCH to alter serving grant for TDM multiplexing is limited because it can only make incremental changes; multiple transmissions are required to ramp up or ramp down depending on the serving grant.

It has been proposed that the absolute grant is given a defined duration in the 3GPP document R2-130249 (3GPP TSG-RAN WG2 #81, 28 Jan.-1 Feb. 2013). In particular, a new grant channel has been proposed, and messages that are transmitted on the new grant channel include both a serving grant and the allocated start/stop time.

A similar proposal was made in the “Feasibility Study for Enhanced Uplink of UTRA FDD”, 3GPP TR25.896 V6.0.0 (March 2004). It discusses, in section 7.1.2.3, that a Node B can explicitly determine when and which User Equipment (UE) should transmit data on the uplink to control the uplink interference level and variation. A Scheduling Assignment is proposed which sets both a Transmission Format Combination Set (TFCS) indicator and subsequent transmission start times and time intervals to be used by the UE.

It has also been proposed, in R1-132519 (3GPP TSG-RAN WG1 Meeting #73, 20 May-24 May 2013), that absolute grants issued on the E-AGCH should only apply to a single TTI, and thus to a particular UE; if a UE receives an E-AGCH transmission which is not intended for it then they should automatically set their serving grant to zero.

In another proposal, R1-120349 (3GPP TSG-RAN WG1 #68, 6-10 Feb. 2012) a UE can have a different serving grant for each Hybrid Automatic Request Repeat (HARQ) process. A form of transmission control and scheduling can be achieved by dividing HARQ processes between UEs. This is limited by the fixed HARQ patterns.

US2011/0128926 discusses a transmission system in which two power levels are determined—high grant and minimum grant. These are then allocated among UEs to obtain an overall RoT budget.

### BRIEF DESCRIPTION OF THE DRAWINGS

FIG. 1 shows schematically a system in which embodiments of the invention can be implemented;

FIG. 2 shows a flow chart for a method of controlling transmission of data on a shared uplink wireless communication channel according to an embodiment;

FIG. 3 shows a flow chart for a method of transmission on a shared wireless uplink communication channel according to an embodiment;

FIG. 4 is a diagrammatic representation of example message timings, when there is a dedicated channel for scheduling messages;

FIG. 5 is a diagrammatic representation of another example message timings, where scheduling messages are time division multiplexed with power grant messages; and

FIG. 6 is a diagrammatic representation of a further example of message timings, where scheduling messages are time division multiplexed with power grant messages across two channels.

### DETAILED DESCRIPTION

According to a first embodiment of the present invention, there is provided a method of transmitting data by a user equipment using a shared uplink wireless communication channel. The method comprises:

receiving a power grant corresponding to the allowed transmission power on the shared uplink wireless communication channel;

receiving a scheduling grant corresponding to whether transmission is allowed on the shared uplink wireless communication channel; and

transmitting data on the shared uplink wireless communication channel according to the power grant and the scheduling grant, wherein the power grant is received separately from the scheduling grant.

According to another embodiment of the invention, there is provided a method of controlling the transmission of data by one or more user equipments on a shared uplink wireless communication channel. The method comprises:

determining a power grant for each of the one or more user equipments, wherein the power grant corresponds to the allowed transmission power on the shared uplink wireless communication channel;

determining a scheduling grant for each of the one or more user equipments, wherein the scheduling grant corresponds to whether the one or more user equipments are allowed to transmit on the shared uplink wireless communication channel;

transmitting the power grant to each of the one or more user equipments; and

transmitting the scheduling grant to each of the one or more user equipments separately from the power grant.

According to a further embodiment of the invention, there is provided an apparatus comprising: a transmitter configured to transmit data on a shared uplink wireless communication channel; a receiver configured to receive data; and a processor. The processor is configured to control the transmitter to transmit data on the shared uplink wireless communication channel by:
receiving a power grant corresponding to the allowed transmission power on the shared uplink wireless communication channel;
receiving a scheduling grant corresponding to whether transmission is allowed on the shared uplink wireless communication channel; and
transmitting data on the shared uplink wireless communication channel according to the power grant and the scheduling grant, wherein the power grant is received separately from the scheduling grant.

According to another embodiment of the invention, there is provided an apparatus comprising: a transmitter; and a processor. The processor is configured to control transmission of data by one or more user equipments on a shared uplink wireless communication channel by:
determining a power grant for each of the one or more user equipments, wherein the power grant corresponds to the allowed transmission power on the shared uplink wireless communication channel;
determining a scheduling grant for each of the one or more user equipments, wherein the scheduling grant corresponds to whether the one or more user equipments are allowed to transmit on the shared uplink wireless communication channel;
transmitting the power grant to each of the one or more user equipments; and

transmitting the scheduling grant to each of the one or more user equipments separately from the power grant.

Further features and advantages of the invention will become apparent from the following description of preferred embodiments of the invention, given by way of example only, which is made with reference to the accompanying drawings.

“Wireless devices” include in general any device capable of connecting wirelessly to a network, and includes in particular mobile devices including mobile or cell phones (including so-called “smart phones”), personal digital assistants, pagers, tablet and laptop computers, wearable communication devices, content-consumption or generation devices (for music and/or video for example), data cards, USB dongles, devices for vehicles (for example connected cars) with wireless communication etc., as well as fixed or more static devices, such as personal computers, game consoles and other generally static entertainment devices, and various other domestic and non-domestic machines and devices, including for example consumer electronics and public safety devices, etc. The term “user equipment” or UE is often used to refer to wireless devices in general, and particularly mobile wireless devices.

The terms “transmitter” and “receiver” are also used herein and are to be construed broadly to include the whole of a device that is transmitting/receiving wireless signals as well as only particular components of a device that are concerned with transmitting/receiving wireless signals or causing or leading to the transmission/reception of wireless signals.

Reference will sometimes be made in this specification to “network”, “network control apparatus” and “base station”. In this respect, it will be understood that the “network control apparatus” is the overall apparatus that provides for general management and control of the network and connected devices. Such apparatus may in practice be constituted by several discrete pieces of equipment. As a particular example in the context of UMTS (Universal Mobile Telecommunications System), the network control apparatus may be constituted by for example a so-called Radio Network Controller operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. Moreover for convenience and by convention, the terms “network”, “network control apparatus” and “base station” will often be used interchangeably, depending on the context.

Embodiments of the invention may provide improved scheduling for uplink transmissions on a shared uplink wireless communication channel by separating the grant of allowed transmission power from the grant of permission to transmit.

In one embodiment, in a method of transmitting data by a user equipment using a shared uplink wireless communication channel, the transmission is made according a power grant and a scheduling grant. The power grant is received separately from the scheduling grant. This embodiment has arisen from a realization that, for a given RoT target, the allocated transmission power to individual UEs generally does not change quickly. Transmission of the power grant is resource intensive, for example because of the amount of data that is required to communicate the allocated power. In HSUPA, there is also the limitation that only a single UE can be given an absolute grant per TTI using the E-AGCH. Rather than receive a power grant every time permission to transmit is given, when the power grant and scheduling grant are received separately, the power grant only needs to be received when it changes. This enables the allowed transmission times to be indicated in the scheduling grant in a less resource intensive way. Thus, by separating the power grant from the scheduling grant, this embodiment allows scheduling to be more responsive and flexible.

In contrast, in prior protocols and proposals, scheduling and power grant information are received together. In some cases, scheduling may be implicit from receipt of the power grant (for example: in the Absolute Grant on the E-AGCH; the relative grant on the E-RGCH; the single TTI transmission permission provided with an absolute grant in R1-132519; and the fixed pattern of the HARQ process in R1-120349). In other cases, the power grant and scheduling grant are transmitted together in the same message (for example: the Scheduling Assignment of 3GPP TR25.896 V6.0.0; the new grant channel proposed in R2-13024; and the high grant and minimum grant of US-2011/0128926). None of the prior methods transmit scheduling information separately from a power grant.

The shared uplink wireless communication can be shared using either TDM (when only one UE is transmitting on the channel at one time) or CDM (where more than one UE is transmitting on the channel at one time) depending on the power grant and the scheduling grant.

The power grant may comprise a single power grant, for example an absolute grant or the cumulative effect of two or more power grants, for example an absolute grant and one or more relative grants.

In an embodiment, the scheduling grant can correspond to the allowed transmission time on the shared uplink wireless communication channel. Examples of information conveyed by the scheduling grant can include:
allowed start and end times for transmission;
a start time and allowed duration of transmission;
information on transmission being allowed or not allowed without explicit reference to timing.

For example, when there is no explicit reference to timing, the scheduling grant can have a defined set of values including values corresponding to “transmission not allowed” or “transmission allowed”. The scheduling grant may then relate to a single TTI and be transmitted for each TTI. For example, the scheduling grant can relate to a TTI a predefined time after it is received. Alternatively, the scheduling grant may apply a scheduling permission which remains in place until a further scheduling grant with a new scheduling permission is received.

The receiving of a scheduling grant can comprise receiving the scheduling grant in a message including scheduling grants for at least two user equipments including the user equipment. This can take advantage of the low resources required for a separate scheduling grant. Including scheduling grants for at least two user equipments in a single message can allow respective scheduling grants for the user equipments to be communicated more efficiently.

Where the scheduling grant is received in a message with scheduling grants for at least two user equipments, the method can further comprise receiving channel parameters for a shared downlink wireless communication channel on which the message including scheduling grants is received, wherein the channel parameters include an indication of which part of the message that includes scheduling grants for at least two user equipments corresponds to a particular user equipment. This allows the particular user equipment to know which scheduling grant applies to it. For example, the scheduling grants may be indicated in a message as consecutive bits and the channel parameters may indicate which of the consecutive bits contain the scheduling grant for the particular user equipment.

Responsive to the scheduling grant including an indication that transmission is not allowed, the power grant can remain the same. In other words the power grant is not changed, is unchanged or is maintained at the same level when transmission is not allowed. This allows the scheduling grant to control scheduling efficiently, without requiring retransmission of a power grant when the user equipment is allowed to transmit again.

The power grant can be received in a first message and the scheduling grant can be received in a second message separate from the first message. The power grant and the scheduling grant can be received on different shared downlink wireless communication control channels. The shared downlink wireless communication control channels can be different physical or logical channels. Alternatively, the power grant and the scheduling grant can both be received on the same shared downlink wireless communication control channel.

It is possible for the power grant to comprise a first power grant and a second power grant. The scheduling grant then corresponds to one of transmission not being allowed, transmission being allowed with a power corresponding to the first power grant and transmission being allowed with a power corresponding to the second power grant. This can allow some control over transmission power with the low resource usage of the scheduling grant. The first power grant can be received in the same message as the second power grant or the first power grant can be received in a different message to the second power grant. Additional power grants can also be provided, such as third and/or fourth power grants, depending on the particular requirements of the communication system. The power grant can be the cumulative effect of an absolute grant and one or more relative grants.

When the scheduling grant corresponds to transmission being allowed with the first or the second power grant, the scheduling grant can have at least three states including: no transmission allowed, transmission allowed with the first power grant and transmission allowed with the second power grant. These three states can be communicated with low resource usage, for example using only two bits.

Alternatively, when the scheduling grant corresponds to whether transmission is allowed with the first or the second power grant, the receiving a scheduling grant can comprise: receiving a first scheduling grant corresponding to whether transmission is allowed with the first power grant; and receiving a second scheduling grant corresponding to whether transmission is allowed with the second power grant.

In some embodiments, the transmission of data on the shared uplink wireless communication channel may use Hybrid Automatic Request Repeat (HARQ).

For synchronous HARQ (where the retransmission pattern is fixed), HARQ retransmissions may be scheduled explicitly or implicitly. When HARQ retransmissions are scheduled implicitly by the scheduling grant, if transmission of new data is allowed by the scheduling grant, HARQ retransmissions of that new data can be made regardless of the scheduling grant. In other words, a single scheduling grant provides permission to transmit new data and all HARQ retransmissions of that new data. This can provide reduced requirement to communicate the scheduling grant. In another example HARQ retransmissions are scheduled explicitly by the scheduling grant. In that case, the scheduling grant applies to both new transmissions and retransmissions: HARQ retransmission can only occur if the scheduling grant allows transmission in the TTI in which a HARQ retransmission occurs. This can allow finer control over transmissions and provide adaptive retransmission gain.

For asynchronous HARQ, a retransmission can be scheduled after an arbitrary delay. When a separate scheduling grant is used with asynchronous HARQ, permission for a retransmission can be granted by the scheduling grant. In that case the scheduling grant also carries information of the HARQ process index for retransmission.

The scheduling grant can be received in various ways. The scheduling grant may be received on a new shared downlink wireless communication channel for carrying scheduling grant messages. Alternatively, the scheduling grant may be received on a shared downlink wireless communication channel which is used for reception of other messages in addition to the scheduling grant, for example messages defining the power grant.

In some embodiments applied to HSUPA systems, the scheduling grant is received on and E-AGCH or a channel having a structure the same as or based upon an E-AGCH. To maximize compatibility with the E-AGCH structure the message can be communicated in a message which is the same length in bits as existing absolute grant messages transmitted on the E-AGCH. For example, the scheduling grant can be received in a message which is 22 bits long after channel decoding. This has the same number of bits as an absolute grant message after channel decoding. It is not necessary for the 22 bits to be allocated in the same way as an absolute grant message. For example, acceptable performance and avoidance of false detection can be provided in an embodiment in which the 22 bits consists of 14 bits serving grant and 8 bit CRC, rather than the 5 bits of absolute grant, 1 bit absolute grant scope and 16 bit CRC of an absolute grant message. 14 bits for the serving grant can allow up to fourteen UEs to be addressed, in the case that a single bit of the 14 bits is used to indicate a binary “transmit” or “not transmit” permission for each of the fourteen UEs. Other embodiments can use the available bits in different ways; for example fewer or more bits than 14 bits can be allocated to data and more or fewer bits then 8 bits can be allocated to the CRC. When the serving grant applies to more than one UE, the CRC can be scrambled by an identifier common to the group of UEs addressed in the scheduling grant.

When the scheduling grant is received on an E-AGCH or a channel having a structure the same as or based upon an E-AGCH, the scheduling grant may be time division multiplexed with power grants (possibly including absolute grants for legacy devices) on the same channel. Two or more channels may be provided, each having a structure the same as or based upon an E-AGCH with the scheduling grant messages time division multiplexed with power grants across at least two of the two or more channels. This can be beneficial when the scheduling grant provides permission for a single TTI because in that case it is necessary to transmit a scheduling grant for each TTI.

Alternatively, two or more E-AGCHs or channels having a structure the same as or based upon an E-AGCH can be provided and the scheduling grant is transmitted on one of the two or more channels which is dedicated to scheduling grant messages.

In some embodiments applied to HSUPA systems, the scheduling grant may be received on an E-RGCH or a channel having a structure the same as or based upon an E-RGCH. Existing relative grant messages on the E-RGCH can already address more than one UE in a single message, for example 40 UEs using E-RGCH signature patterns. Some embodiments may use the same transmission format as existing E-RGCH messages. The scheduling grant messages may be identified from relative grant messages by using a different signature pattern for the scheduling grant from the relative grant.

The message format defined for E-RGCH allows a UE to be provided with three values. These can be advantageous when a separate scheduling grant is combined with first and second power grants. For example, the scheduling grant can comprise an indication with at least three states including: transmission not allowed, transmission allowed with a first power grant and transmission allowed with a second power grant.

When the scheduling grant is transmitted on an E-RGCH or a channel having a structure the same as or based upon an E-RGCH, relative grant messages indicating a change to the power grant can also be received on the same E-RGCH, for example distinguished from the scheduling grant by a different signature pattern. As was the case when a separate scheduling grant is transmitted on an E-AGCH or a channel having a structure the same as or based upon an E-AGCH discussed above, the relative grant messages can be time division multiplexed with the scheduling grant messages across one or more channels or the scheduling grant could be transmitted on a dedicated channel for the scheduling grant. Multiplexing using signature patterns is also possible.

Regardless of the downlink channel used to receive a scheduling grant, the scheduling grant could include an indication of whether it applies to a first power grant or a second power grant. For example, the scheduling grant may be at least partially scrambled by a first identifier or at least partially scrambled by a second identifier, wherein the first identifier indicates scheduling for a first power grant and the second identifier indicates scheduling for a second power grant. For example, the CRC could be scrambled by a different identifier for the first power grant than for the second power grant.

More than one scheduling grant message may be received at generally the same time, for example substantially simultaneously or within the same TTI. This can allow more UEs to be provided with a scheduling grant (by addressing different devices in each scheduling grant, in which case only one scheduling grant message applies to a particular UE) or allow a scheduling grant for two or more power grants to be communicated to a particular UE in separate messages in the same TTI.

Thus far, embodiments have been discussed in terms of the messages received and action taken by a user equipment. The invention also applies to control of the transmission of data by one or more devices on a shared uplink wireless communication channel, for example control by a network apparatus. Embodiments applied to the control of the transmission of data follow, these embodiments can include equivalent features those discussed above. For example, where features relating to the reception of scheduling grants and/or power grants were discussed above, corresponding features can be provided in the way in which scheduling grants and power grants are transmitted in the following embodiments. The features which follow are those which apply only to control of transmission of data, however these embodiment are not limited to those features. In an embodiment, the method performed by such a network apparatus when cooperating with each of one or more user equipments comprises:

determining a power grant for each of the one or more user equipments, wherein the power grant corresponds to the allowed transmission power on the shared uplink wireless communication channel;

determining a scheduling grant for each of the one or more user equipments, wherein the scheduling grant corresponds to whether the one or more devices are allowed to transmit on the shared uplink wireless communication channel;

transmitting the power grant to each of the one or more user equipments; and

transmitting the scheduling grant to each of the one or more user equipments separately from the power grant.

This allows the network to schedule the transmissions of the UEs in a flexible manner by transmitting the power grant separately from the scheduling grant. The steps of determining a power grant and a scheduling grant can involve use of any suitable method. For example, the power grant may be set at a level such that a RoT target is reached when a single UE transmits at the maximum power of the power grant. The power grant may also be set at a level such that a RoT target is reached when two or more UEs transmit in the same TTI. It is therefore possible to set the power grant at an appropriate level depending on the priorities for the network.

The scheduling grant may be determined taking into account the determined power level. For example, the step of determining a scheduling grant may involve selecting a single wireless to transmit in a particular TTI, thus enabling efficient time division multiplexing when the power grant corresponds to a transmission from a single UE that will reach the RoT target. In another example, the step of determining a scheduling grant may involve selecting a plurality of UEs to transmit in a single TTI, enabling efficient code division multiplexing, when the power grant corresponds to a level requiring several UEs to transmit to reach the RoT target. Network devices configured according to this embodiment can therefore schedule user equipments flexibly depending on the requirements of the communication system and the UEs themselves.

In some embodiments, the step of determining a power grant comprises: determining a first power grant; and determining a second power grant different from the first power grant. The step of determining a scheduling grant then comprises determining at least whether respective ones of the one or more user equipments should not transmit, transmit using the first power grant, or transmit using the second power grant. This allows, for example, the first power grant to relate to the case where a single UE transmits on the shared uplink wireless communication channel and the second power grant to relate to the case where two or more UEs transmit substantially simultaneously on the shared uplink wireless communication channel. In another example, the first power grant may be for use when a first number of devices are transmitting simultaneously on the shared uplink wireless communication channel and the second power grant may be for use when a second number of devices are transmitting simultaneously on the shared uplink wireless communication channel, the second number of devices being greater than the first number of devices.

In some embodiments the shared uplink wireless communication may use HARQ. In such embodiments the step of determining a scheduling grant can involve HARQ retransmissions. The HARQ retransmissions can be taken into account in various ways. For example, HARQ retransmissions may be explicitly scheduled by the scheduling grant. In that case it is necessary to consider the HARQ retransmission pattern for whether a retransmission should be scheduled, as well as an overall RoT target. In another example, HARQ retransmissions can be implicitly scheduled (such as the case when a single scheduling grant provides permission for the transmission of new data and HARQ retransmissions of that new data), in which case it is necessary to consider the contribution of potential HARQ retransmissions to the overall thermal budget when scheduling other transmissions.

The methods discussed above can be applied to an apparatus, such as a user equipment, transmitting data to a network apparatus and a network apparatus controlling the transmission of data by one or more user equipments. The user equipment and network apparatus can be configured for use in a High Speed Uplink Packet Access (HSUPA) system. The network apparatus can be, for example, a base station or an evolved node B in a HSUPA system.

Having discussed features of various embodiments, some more detailed examples will be given. By way of example an embodiment of the invention will now be described in the context of a 3GPP wireless communications system supporting communication using High Speed Packet Access (HSPA) radio access technology and in particular HSUPA. However, it will be understood that this is by way of example only and that other embodiments may involve wireless networks using other radio access technologies, such as LTE or IEEE802.16 WiMax systems.

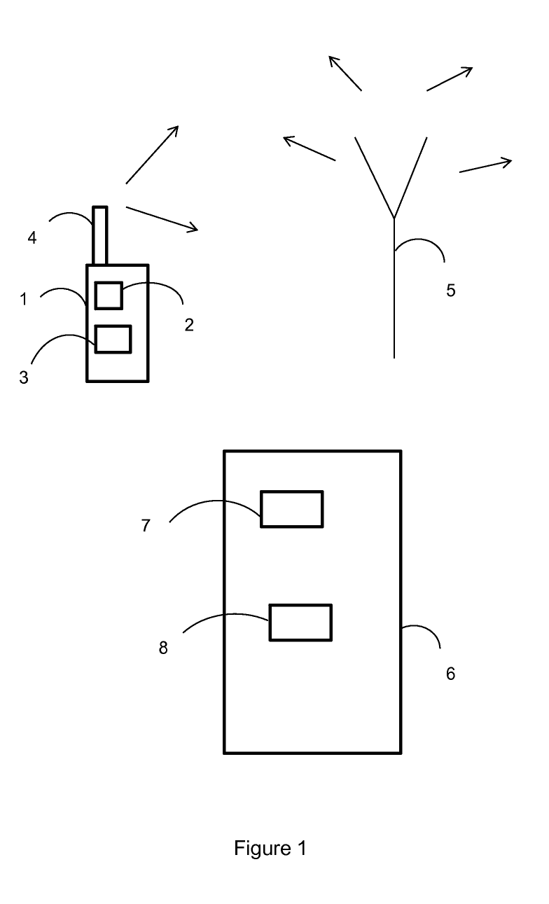

FIG. 1 shows schematically a user equipment or wireless device, in this case in the form of a mobile phone/smartphone 1. The user equipment 1 contains the necessary radio module 2, processor(s) and memory/memories 3, antenna 4, etc. to enable wireless communication with the network. The user equipment 1 in use is in communication with a radio mast 5. As a particular example in the context of UMTS (Universal Mobile Telecommunications System), there may be a network control apparatus 6 (which may be constituted by for example a so-called Radio Network Controller) operating in conjunction with one or more Node Bs (which, in many respects, can be regarded as “base stations”). As another example, LTE (Long Term Evolution) makes use of a so-called evolved Node B (eNB) where the RF transceiver and resource management/control functions are combined into a single entity. The term “base station” is used in this specification to include a “traditional” base station, a Node B, an evolved Node B (eNB), or any other access point to a network, unless the context requires otherwise. The network control apparatus 6 (of whatever type) may have its own processor(s) 7 and memory/memories 8, etc.

In order to facilitate operation at higher RoT values, more flexible scheduling of transmissions would be beneficial.

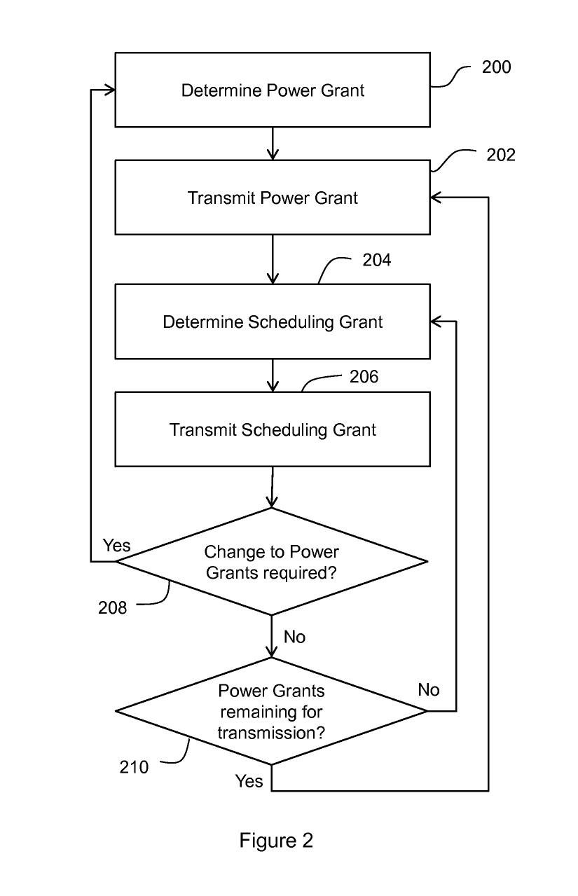

FIG. 2 depicts a method of controlling transmission of data on a shared uplink wireless communication channel according to an embodiment of the invention. The method can be implemented by, for example a network apparatus node configured to execute a set of computer program instructions in the form of a computer program to control the communication of UEs with the network apparatus as has been described above.

First, at step 200 one or more power grants are determined for UEs configured to communicate with the network apparatus over the shared uplink wireless communication channel. One or more of the UEs in communication with the network apparatus may be configured to use the shared uplink wireless communication channel, for example in a HSUPA system those UEs in CELL_FACH state may be registered to use the shared uplink wireless communication channel. Any suitable method can be used to determine the power grants for the UEs. For example, in some methods of determining the power grant a target RoT value for the network apparatus is considered and the power grants are determined to enable the UEs to be scheduled to achieve as close to the target RoT value as possible. In one method, the power grant may be determined to be a value such that a transmission from a single UE meets the target RoT value. In another method the power grant may be determined to be a value such that when a predetermined number of UEs transmit substantially simultaneously, for example within the same TTI, the target RoT value is met.

The computer program then proceeds to step 202, which involves transmission of the determined power grant(s). Depending on the signaling of the underlying wireless communication system it may take some time to transmit all the power grants. For example, due to the relatively high resources required to transmit a power grant it may be possible to transmit only one power grant in a particular TTI. If it is not possible to transmit all the power grants, as many as possible are transmitted. Priority may be given to transmitting power grants to UEs known to have more data to transmit, for example based on feedback received from UEs on an uplink control channel.

Next, at step 204, the scheduling grant(s) are determined. This can use, for example, knowledge of the power grants assigned to particular UEs and the data transmission requirements of the UEs, for example based on feedback received from the UEs on an uplink control channel. The scheduling grant aims to provide permission to particular ones of the UEs such that a target RoT value is met. This may be achieved by, for example, giving only one UE permission to transmit in a particular TTI because transmissions with a high RoT value work most effectively when only a single UE is transmitting at the same time. In this scheduling method, the UEs are scheduled in a time division multiplexing method. In another method, two or more UEs are given permission to transmit in the same TTI. This can be suitable where a UE is power limited and unable to transmit at sufficient power to meet the RoT target on its own. In such cases capacity can be maximized by scheduling two or more UEs to transmit so that the RoT target is met.

Once the scheduling grants have been determined, they are transmitted at step 206. The scheduling grant requires relatively low resources to transmit because the information it contains is small (for example it may be a binary value indicating the presence or absence of permission to transmit). Embodiments of the invention can provide the scheduling grant to all configured UEs in a single TTI. This can be achieved by, for example, including serving grants for several UEs in the same message. Mechanisms for transmitting the scheduling grant are discussed in more detail below.

At step 208 it is determined whether a change to the power grants is required. Situations in which a change to power grants may be required include: the configuration of one or more user equipments not previously configured to use the shared uplink wireless communication channel; reconfiguration of a device already configured to use the shared uplink wireless communication channel, such as in response to feedback information received from the UE on an uplink control channel; and a change in the overall target RoT value. If a change is required the computer program returns to step 200. If no change is required, the computer program proceeds to step 210 where it is determined whether any power grants are queued for transmission. If there are, the computer program returns to step 202; otherwise the computer program returns to step 204.

The method of FIG. 2 may run continuously to determine power grants and scheduling grants. For example, the method may be completed once for each TTI on the shared uplink wireless communication channel, in which case the scheduling grant can apply to a single TTI. The method may also run less frequently, for example less than every TTI, in which case the scheduling grant can apply to more than one TTI. When the scheduling grant applies to more than one TTI it can be set to a value that remains in place until another scheduling grant is received or scheduling grants for individual TTIs may be specified in the scheduling grant.

As described above the exemplary method of FIG. 2 involves a sequential execution of a series of steps. Other embodiments may carry out the steps in a different order and/or concurrently. For example the power grants and scheduling grant may be transmitted substantially simultaneously. Further embodiments may use an event driven method, for example determining the power grants responsive to an event triggering power grants to be determined and/or determining the scheduling grants responsive to feedback received from the UEs regarding uplink buffer states or other information.

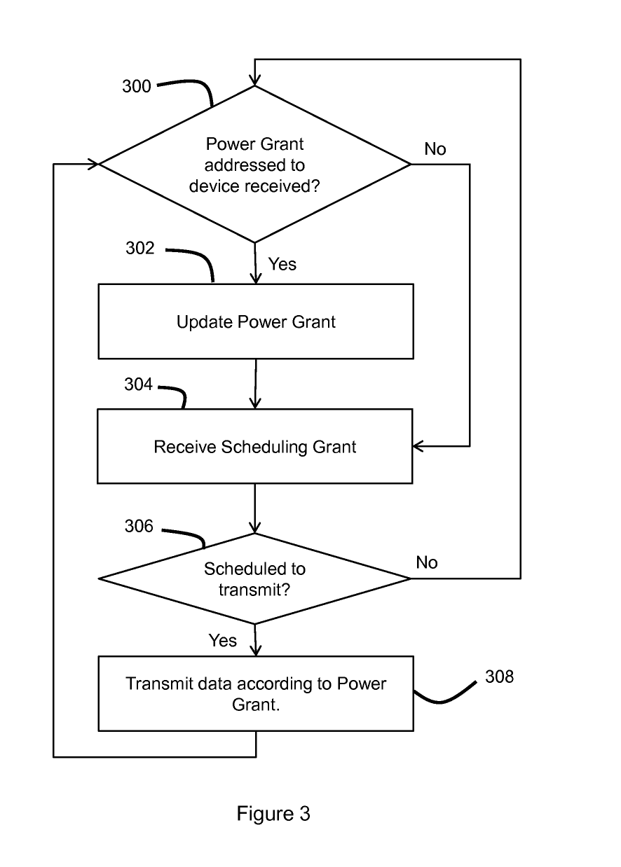

FIG. 3 is a flow chart depicting a method of transmission on a shared uplink wireless communication channel for use by a UE configured to execute a set of computer program instructions in the form of a computer program, for example a UE which is controlled by a network apparatus implementing the method of FIG. 2.

First at step 300 the UE determines whether a power grant addressed to the UE has been received. This may be achieved by, for example, monitoring a shared wireless downlink communication channel for power grant messages and then determining whether a received message is addressed to the UE, for example by checking whether a CRC is scrambled with an identifier of the UE. If a power grant is received, the computer program proceeds to step 304; otherwise execution proceeds to step 302 where the power grant is updated. The power grant may define the allowed transmission power in any suitable way, for example by indicating the transmission power directly or by referring to a predefined transmission format with a predetermined transmission power.

At step 304 a scheduling grant is received. For example a shared wireless downlink communication channel may be monitored for scheduling grant messages addressed to the user equipment, for example by checking whether the CRC is scrambled with an identifier of the user equipment or a group of user equipments including the user equipment. The scheduling grant indicates whether transmission is or is not allowed on the shared uplink wireless communication channel.

Next, at step 306, the user equipment determines whether the scheduling grant gives permission for the user equipment to transmit. If transmission is allowed, execution proceeds to step 308, where data is transmitted on the shared uplink wireless communication channel according the transmission power defined by the power grant, otherwise execution returns to step 300. Transmission of data in step 308 may be for a single TTI, in the case that the scheduling grant applies to a single TTI, or more than one TTI, in the case that the scheduling grant applies to more than one TTI.

The exemplary method of FIG. 3 involves a series of steps that are performed sequentially; however other embodiments may carry out the steps in a different order or concurrently. Some embodiments may provide an event driven architecture, for example the power grant may be updated responsive to receipt of a power grant addressed to the user equipment.

In both the methods of FIG. 2 and FIG. 3, the power grant was described as a single value and the scheduling grant applied to whether transmission was allowed with that single value of power grant. In further embodiments, scheduling flexibility can be improved by determining two or more power grants for a UE and communicating them to the UEs. UEs can then be scheduled to transmit at different power levels in an efficient manner by referring to a particular power grant in the scheduling grant or providing a scheduling grant for each power grant.

Having described the general methods for control of transmission and for transmission using a power grant separate from a scheduling grant, examples of how the power grant and the scheduling grant can be transmitted will now be described.

In a first example, applied to a HSUPA system, the power grant and the scheduling grant are both communicated on an E-AGCH or a channel having a structure the same as or based upon an E-AGCH. To maximize compatibility with existing HSUPA protocols, the power grant can be transmitted using existing protocols and message formats defined for the transmission of an absolute grant on an E-AGCH. For example, when a UE is configured with channel parameters to access the shared uplink wireless communication channel, such as when it is configured in CELL_FACH mode, the network may indicate in the channel parameters that an absolute grant addressed to the UE should be interpreted as a power grant to be used only when scheduled by a corresponding scheduling grant. This could be indicated an information element in the channel parameters.

When the scheduling grant is transmitted on an E-AGCH or a channel having a structure the same as or based upon an E-AGCH it is advantageous for it to have the same number of bits as an existing absolute grant message transmitted on the channel. This maximizes compatibility. As discussed above, at present, absolute grant messages on the E-AGCH consist of 22 bits before channel coding: 5 bits absolute grant, 1 bit scope and 16 bits CRC scrambled by the identifier of the user equipment that it applies to. The scheduling grant message format therefore also has 22 bits in this example. To increase the efficiency of scheduling grant messages (by reducing resource use) it is desirable to transmit scheduling grants for more than one UE in the same message. It has been found that combining 14 bits for the scheduling grant data and 8 bits for the CRC gives a good balance between the number of UEs that can be addressed in a message and avoiding false detections by devices not intended to be addressed by the message. Other splits between data and CRC can also be used.

Each UE is notified of a group identifier for the scheduling grant messages and an index or other information indicating the bit or bits within the scheduling data that apply to the UE. The CRC is scrambled by the group identifier. For example, in an embodiment where the scheduling grant is a binary “transmit” or “not transmit” indication, a UE may be given the index of bit that relates to its scheduling grant. In another embodiment, where the scheduling grant relates to permission to transmit using two or power grants, two or more bits of the scheduling grant may be used to refer to a particular power grant for which transmission is allowed.

The absolute grant message may be interpreted in a different manner when used to indicate a power grant for use in combination with a scheduling grant. The “scope” bit is generally less important with the improved scheduling provided by the scheduling grant and so could be used to indicate different information. For example, the “scope” bit of an absolute grant message can be used to indicate that either a first power grant or a second power grant is configured in the message.

When a channel having a structure the same as or based upon an E-AGCH is also used for the scheduling grant, the scheduling grant messages must be sent along with the absolute grant messages. There are number of ways that this can be achieved, depending on the number and way in which the channels are configured.

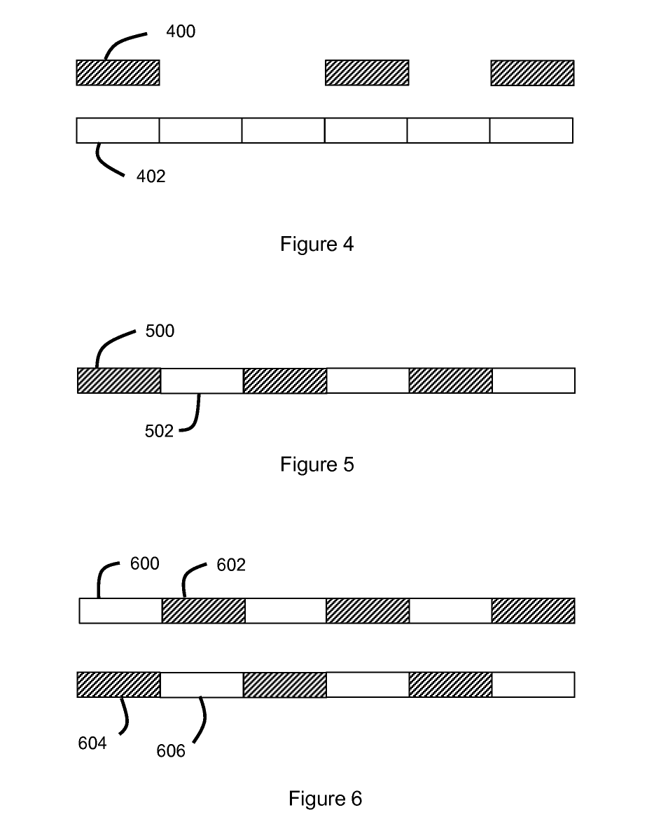

FIG. 4 is a diagrammatic representation of message timings when an additional channel is configured for the scheduling grant. Each rectangle represents a TTI in which a message is sent, with diagonal hatching indicating an absolute grant message 400 and a blank rectangle indicating a scheduling grant message 402. In this example the scheduling grant provides permission for a single TTI and therefore is transmitted every TTI. In contrast, the power grant transmitted in messages 400 changes relatively infrequently so there are some TTIs in which no power grant message is transmitted. Individual power grant messages 400 may define a power grant for a single UE.

FIG. 5 is a diagrammatic representation of message timings in which power grant messages 500 are time division multiplexed with scheduling grant messages 502 on a single channel. As can be seen, the requirement to transmit power grant messages means that the scheduling grant cannot be transmitted every TTI in this case. The scheduling grant may therefore apply to more than one TTI or remain in place until updated with another scheduling grant. Although FIG. 5 depicts a 50/50 share of the channels between power grant and scheduling grant messages other splits are possible.

FIG. 6 is a diagrammatic representation of message timings in which two or more channels are provided and power grant messages 602, 604 are time division multiplexed on each channel with scheduling messages 600, 606. In this embodiment, a scheduling grant message 600, 606 is transmitted every TTI but on different channels to allow power grant messages to also be transmitted. Another embodiment may apply each channel to a different power grant. In that case power grant messages 602 on the first channel relate to a first power grant, scheduling messages 600 on the first channel relate to scheduling with the first power grant, power grant messages 604 on the second channel relate to a second power grant and scheduling messages 606 on the second channel relate to scheduling with the first power grant.

In a second example, also applied to a HSUPA system, the scheduling grant is communicated on an E-RGCH or a channel having a structure the same as or based upon an E-RGCH. Relative power grants, to make incremental changes to the configured power grant, may also be transmitted on the channel having a structure the same as or based upon an E-RGCH using existing relative grant messages.

As noted above, the existing message format for relative grant messages on the E-RGCH can address up to 40 UEs in a single message. It also allows one of three possible values to be communicated to each UE. The combination of these features makes existing relative grant messages well suited to the scheduling grant. For compatibility the same message format can be used for the scheduling grant messages as for the relative grant messages. The scheduling grant and the relative grant can be distinguished by, for example using different signature patterns. For example, the three values that can be signaled in an existing E-RGCH message may be used to indicate “No transmission allowed”, “transmission allowed with a first power grant” (such as for time division multiplexing of UEs or a relatively small number of UEs transmitting) and “transmission allowed with a second power grant” (such as for code division multiplexing with more UEs transmitting simultaneously than when the first power grant is scheduled).

In other embodiments in which the scheduling grant is transmitted on a channel having a structure the same as or based upon an E-RGCH a new message format may be used with the same number of bits as a relative grant message using the principles described above for a scheduling grant on a channel having a structure the same as or based upon an E-AGCH.

In further embodiments, the scheduling grant may include timing information. For example, rather than always applying to the next Cell System Frame Number (SFN), a timing for applying the scheduling grant can be specified. The scheduling grant in SFN i can be correspond to the uplink transmission in subframe i+m, where m can be specified for 2 ms TTI case and 10 ms TTI cases respectively. This can reduce scheduling delay

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-7. (canceled)

8. A method of controlling a transmission of data by one or more user equipments on a shared uplink wireless communication channel, the method comprising:
determining a power grant for each of the one or more user equipments, wherein the power grant corresponds to an allowed transmission power on the shared uplink wireless communication channel;
determining a scheduling grant for each of the one or more user equipments, wherein the scheduling grant corresponds to whether the one or more user equipments are allowed to transmit on the shared uplink wireless communication channel;
transmitting the power grant to each of the one or more user equipments; and
transmitting the scheduling grant to each of the one or more user equipments separately from the power grant.

9. The method according to claim 8, wherein transmitting the scheduling grant comprises transmitting a message including scheduling grants for at least two user equipments.

10. The method according to claim 9, further comprising:
transmitting channel parameters for a shared downlink wireless communication channel to respective ones of the one or more user equipments, wherein the channel parameters include an indication of which part of the message including scheduling grants corresponds to the respective user equipment.

11. The method according to claim 8, wherein:
determining the power grant comprises:
determining a first power grant; and
determining a second power grant different from the first power grant; and
determining the scheduling grant comprises determining whether respective ones of the one or more user equipments should:
not transmit;
transmit using the first power grant; or
transmit using the second power grant.

12. The method according to claim 8, wherein the shared uplink wireless communication channel uses Hybrid Automatic Repeat Request (HARQ) and, determining the scheduling grant, HARQ retransmissions are considered.

13. The method according to claim 8, wherein the scheduling grant is transmitted on at least one of an Enhanced-Dedicated Channel Absolute Grant Channel (E-AGCH) a channel having a structure the same as or based upon an E-AGCH, an Enhanced-Dedicated Channel Relative Grant Channel (E-RGCH), and a channel having a structure the same as or based upon an E-RGCH.

14. (canceled)

15. An apparatus comprising:
a transmitter configured to transmit data on a shared uplink wireless communication channel;
a receiver configured to receive data; and
a processor configured to control the transmitter to transmit data on the shared uplink wireless communication channel by:
receiving a power grant corresponding to an allowed transmission power on the shared uplink wireless communication channel;
receiving a scheduling grant corresponding to whether transmission is allowed on the shared uplink wireless communication channel; and
transmitting data on the shared uplink wireless communication channel according to the power grant and the scheduling grant, wherein the power grant is received separately from the scheduling grant.

16. The apparatus according to claim 15, wherein the receiving a scheduling grant comprises receiving the scheduling grant in a message including scheduling grants for at least two apparatuses including the apparatus.

17. The apparatus according to claim 16, wherein the processor is further configured to control the transmitter by:
receiving channel parameters for a shared downlink wireless communication channel on which the message including scheduling grants is received, wherein the channel parameters include an indication of which part of the message including scheduling grants for at least two user equipments corresponds to the user equipment.

18. The apparatus according to claim 15, wherein, responsive to the scheduling grant including an indication that transmission is not allowed, the power grant remains the same.

19. The apparatus according to claim 15, wherein:
the power grant comprises a first power grant and a second power grant; and
the scheduling grant corresponds to one of transmission not being allowed, transmission being allowed with the first power grant and transmission being allowed with the second power grant.

20. The apparatus according to claim 15, wherein the receiver is configured to receive the scheduling grant on at least one of an Enhanced-Dedicated Channel Absolute Grant Channel (E-AGCH), a channel having a structure the same as or based upon an E-AGCH, an Enhanced-Dedicated Channel Relative Grant Channel (E-RGCH), and a channel having a structure the same as or based upon an E-RGCH.

21. (canceled)

22. The apparatus according to claim 15, wherein the apparatus is configured for use in High Speed Uplink Packet Access (HSUPA) system.

23. (canceled)

24. An apparatus comprising:
a transmitter; and
a processor configured to control transmission of data by one or more user equipments on a shared uplink wireless communication channel by:
determining a power grant for each of the one or more user equipments, wherein the power grant corresponds to an allowed transmission power on the shared uplink wireless communication channel;
determining a scheduling grant for each of the one or more user equipments, wherein the scheduling grant corresponds to whether the one or more user equipments are allowed to transmit on the shared uplink wireless communication channel;
transmitting the power grant to each of the one or more user equipments; and
transmitting the scheduling grant to each of the one or more user equipments separately from the power grant.

25. The apparatus according to claim 24, wherein transmitting the scheduling grant comprises transmitting a message including scheduling grants for at least two user equipments.

26. The apparatus according to claim 25, wherein the processor is further configured to transmit channel parameters for a shared downlink wireless communication channel to respective ones of the one or more user equipments, wherein the channel parameters include an indication of which part of the message including scheduling grants corresponds to the respective user equipment.

27. The apparatus according to claim 24, wherein:
determining the power grant comprises:
determining a first power grant; and
determining a second power grant different from the first power grant; and
determining the scheduling grant comprises determining whether respective ones of the one or more user equipments should:
not transmit;
transmit using the first power grant; or
transmit using the second power grant.

28. The apparatus according to claim 24, wherein the processor is further configured to control transmission of data on the shared uplink wireless communication channel using Hybrid Automatic Repeat Request (HARQ) and, in determining the scheduling grant, HARQ retransmissions are considered.

29. The apparatus according to claim 24, wherein the transmitter is configured to transmit the scheduling grant on an Enhanced-Dedicated Channel Absolute Grant Channel (E-AGCH) or a channel having a structure the same as or based upon an E-AGCH.

30. The apparatus according to claim 24, wherein the transmitter is configured to transmit the scheduling grant on an Enhanced-Dedicated Channel Relative Grant Channel (E-RGCH) or a channel having a structure the same as or based upon an E-RGCH.
